(19) United States
(12) Patent Application Publication
(10) Pub. No.: US 2006/0044455 A1
(43) Pub. Date: Mar. 2, 2006

(54) Lens-positioning device of camera module

(75) Inventors: Oui Serg Kim, Seoul (KR); In Bae Chang, Seoul (KR); Burhanettin Koc, Sungnam (KR); Dae Hyun Jeong, Suwon (KR); Woon Ki Kim, Hwasung (KR); Jung Ho Ryu, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 11/007,306

(22) Filed: Dec. 9, 2004

(30) Foreign Application Priority Data
Sep. 2, 2004 (KR) 2004-69985

(51) Int. Cl. H04N 5/225

(52) U.S. Cl. 348/360

(57) ABSTRACT

A lens-positioning device of a camera module designed to provide a focusing function or an optical zoom function. In the lens-positioning device, an actuating part includes a ring-shaped piezoelectric actuator and a rotating plate positioned on an upper surface of the piezoelectric actuator. A positioning part is provided with a hollow barrel holder and linearly moved in the direction of the optical axis of the lens upon rotation of the rotating plate. The hollow barrel holder contacts the upper surface of the rotating plate. A hollow housing receives the actuating part and the positioning part and having a guide means to guide the positioning part to be linearly moved in the direction of the optical axis of the lens. The lens-positioning device can have ultra-miniaturized size through the piezoelectric actuator, and a minute focusing can be realized through minute positioning of the lens, allowing high resolution and high sharpness images.

### RELATED APPLICATION

The present application is based on, and claims priority from, Korean Application Number 2004-0069985, filed Sep. 2, 2004, the disclosure of which is hereby incorporated by reference herein in its entirety.

### BACKGROUND OF THE INVENTION

1. Field of the Invention

The present invention relates to a lens-positioning device of a camera module, and more particularly to a lens-positioning device of a camera module, designed to convert rotational movement of a rotating plate with an actuating force by a traveling wave generated by a piezoelectric actuator to linear movement of the lens, thereby allowing focusing function and providing a close-up or optical zoom function.

2. Description of the Related Art

Generally, a camera comprises a plurality of lenses, and is constructed such that the optical focal length can be adjusted by changing relative distances between the lenses by moving respective lenses. Recently, mobile phones with a camera mounted thereon have been developed, enabling still images and moving images to be taken. The performance of such mobile phone cameras is gradually increasing, such that they provide ever-higher resolution and image quality.

FIG. 1 is a perspective view of a conventional camera module without a focus adjusting function.

A conventional camera module as shown in FIG. 1 has an image sensor 170 and a filter assembled to a lower portion of a housing 110, and a plurality of lenses provided to a lens barrel 120.

The lens barrel 120 is fixed into the housing 110 through an epoxy member and the like, after a lens array 130 and the image sensor 170 are focused by means of threads formed around an inner peripheral surface and an outer peripheral surface of the lens barrel 120, respectively.

However, in such a fixed focus manner, since it is impossible to set focus to a specific distance from an object, there is a problem in that sharpness of an image is limited.

Accordingly, it is necessary for a 1 mega-pixel or greater camera module to have a focusing function.

For this purpose, it has been suggested to provide a mobile phone having a camera module equipped with an automatic focus adjusting device, a close-up device, an optical zoom device, and the like. However, it is not appropriate to install the conventional camera on the small sized mobile phone.

That is, according to the prior art, a DC motor is utilized as a driving source of focusing and/or optical zoom functions by changing a relative distance between the image sensor and the lenses, and in this case, a plurality of reduction gears are connected with each other. As a result, it is difficult not only to provide accurate control of positioning of the lens for performing accurate focusing due to reduction of a response speed and variation of a rotational velocity, but also to realize the focusing within an extremely limited space in the mobile phone due to its complicated structure and large volume.

In order to solve the problems as mentioned above, it can be considered to apply a lens-positioning means, required for performing the optical zoom function, to an automatic focusing.

FIGS. 2 and 3 are constructional views illustrating an essential component of a conventional zoom lens-coupled device to automatically and manually perform the optical zoom function, respectively.

As shown in FIG. 2, the zoom lens-coupled device comprises a cylindrical zoom lens case 250 having threads around an inner peripheral surface thereof, a zoom lens 210, a camera 240 having threads 241 formed around an outer peripheral surface of the camera 240, and the like, wherein, when the zoom lens case 250 is rotated by hand, the distance between the zoom lens 210 and the camera 242 is varied, allowing zooming-in or zooming-out of the lens.

In such a manner, the lens is not automatically moved, and thus, although this manner can be applied to the optical zoom function, it cannot be applied to the focusing.

That is, in the case where the lens has a small diameter, since the lens has a lower focal length, a moving distance of the lens is also decreased upon adjustment of the focal length. Accordingly, with the construction as shown in FIG. 2, it is very difficult to minutely adjust focal length by manually rotating the zoom lens case 250.

Additionally, with the construction as described above, the zoom lens 210 is rotated, resulting in change of an optical axis, whereby high resolution cannot be accomplished.

Meanwhile, referring to FIG. 3, in order to realize the automatic zoom function, the zoom lens-coupled device further comprises a motor 270, and a positioning device 260 to transfer the zoom lens-coupled device with a actuating force of the motor 270. Additionally, the camera 240 has a sliding groove 241 formed around an outer peripheral surface of the camera 240 in a longitudinal direction, and the zoom lens case 250 has a protrusion 255 formed around an inner peripheral surface of the zoom lens case 250 to fit into the sliding groove 241.

As the motor 270 is driven by user's keypad input or sensor detection, a positioning pinion 262 fixed to a driving shaft 271 is rotated, and moved forward or backward in a longitudinal direction of a positioning rack 261. As a result, the zoom lens case 250 is moved linearly, and changes a distance of the zoom lens 210 to the camera 240, thereby providing the optical zoom function.

However, with such a construction, it is also necessary to provide a positioning device on an outer surface of the zoom lens case 250. As a result, the problem of enlarging the volume of the camera module cannot be basically solved, and thus, this construction is not appropriate for a miniaturized optical device, which must be driven within an extremely restricted space.

Accordingly, in order to allow the camera for the mobile phone to perform various functions, such as the focusing, the close-up, the optical zoom, and the like, it is necessary to provide a lens-positioning device, which can have ultra-miniaturized size while allowing high resolution through minute positioning of the lens.

### SUMMARY OF THE INVENTION

The present invention has been made to solve the above problems, and it is an object of the present invention to provide a lens-positioning device of a camera module, designed to have a miniaturized size and simple construction, and to allow accurate positioning of the lens.

It is another object of the present invention to provide a lens-positioning device of a camera module, designed to accomplish a high resolution and high sharpness image by minute focusing through accurate positioning of the lens.

In accordance with one aspect of the present invention, the above and other objects can be accomplished by the provision of a lens-positioning device of a camera module, comprising: an actuating part including a ring-shaped piezoelectric actuator to generate a mechanical actuating force by virtue of a voltage applied to the piezoelectric actuator and a rotating plate positioned on an upper surface of the piezoelectric actuator to be rotated around an optical axis of a lens in response to the actuating force generated by the piezoelectric actuator; a positioning part provided with a hollow barrel holder and linearly moved in a direction of an optical axis of the lens upon rotation of the rotating plate, the hollow barrel holder contacting an upper surface of the rotating plate and having the lens fixed into the barrel holder; and a hollow housing receiving the actuating part and the positioning part and having a guide means to guide the positioning part to be linearly moved in the direction of the optical axis of the lens, wherein when the rotating plate is rotated in response to the actuating force generated by the piezoelectric actuator, the positioning part is guided through the guide means of the housing by contact between a lower portion of the barrel holder and the upper surface of the rotating plate, and is then moved in the direction of the optical axis of the lens.

Preferably, the actuating part further comprises a bottom plate provided with an image sensor, and having a mounting groove depressed on an upper surface of the bottom plate to mount the piezoelectric actuator thereon. The piezoelectric actuator may be a traveling wave-actuating type piezoelectric actuator.

Preferably, the rotating plate has one or more slant cams protruded from the upper surface thereof, gradually increasing in height, and the barrel holder has one or more cam followers corresponding to the slant cams and protruded from the lower surface of the barrel holder to contact the slant cams. The positioning part may be moved by virtue of contact between the slant cams and the cam followers upon the rotation of the rotating plate around the optical axis of the lens.

More preferably, the slant cams are protruded from the upper surface of the rotating plate, and spaced a uniform distance at each predetermined angle in a circumferential direction around the optical axis of the lens. The cam followers may be protruded from the lower surface of the barrel holder to correspond to the slant cams.

Preferably, the barrel holder has one or more slide portions protruded on an outer peripheral surface thereof, and the housing has guide portions depressed on an inner peripheral surface corresponding to the slide portions to receive and allow the slide portions to slide therein, the slide portions and the guiding part being formed parallel to the optical axis of the lens.

Preferably, the bottom plate has a hollow cylinder-shaped rotation guide protruded from the upper surface thereof and having the optical axis of the lens as a central axis, the rotation guide being inserted into an inner peripheral surface of the rotating plate penetrating through the center of the rotating plate to restrict movement in a radial direction of the rotating plate upon the rotation of the rotating plate.

Preferably, the positioning part further comprises a first elastic member to elastically compress the slant cams and the cam followers so that they contact each other, and the actuating part further comprises a second elastic member to compress the upper surface of the piezoelectric actuator and the lower surface of the rotating plate with a preloaded elastic force, the first and second elastic members being a ring-shaped and preloaded wave spring.

The lens-positioning device may further comprise a controller to control actuation of the piezoelectric actuator by means of a signal from a sensor to detect a distance of an object or indication of a user. The lens-positioning device may further comprise an additional group of lenses comprising one or more lens to conduct an optical zoom or close-up function.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a conventional camera module without a focusing function;

FIG. 2 is a perspective view illustrating an essential component of a conventional zoom lens-coupled device to manually perform a zoom function;

FIG. 3 is a perspective view illustrating an essential component of the conventional zoom lens-coupled device to automatically perform the zoom function;

FIG. 4 is a perspective view illustrating an essential component of a lens-positioning device according to the present invention;

FIGS. 5a to 5c are cross-sectional views illustrating the central portion of a lens-positioning device according to one embodiment of the present invention; and

FIG. 6 is a cross-sectional view illustrating the central portion of a lens-positioning device according to another embodiment of the present invention.

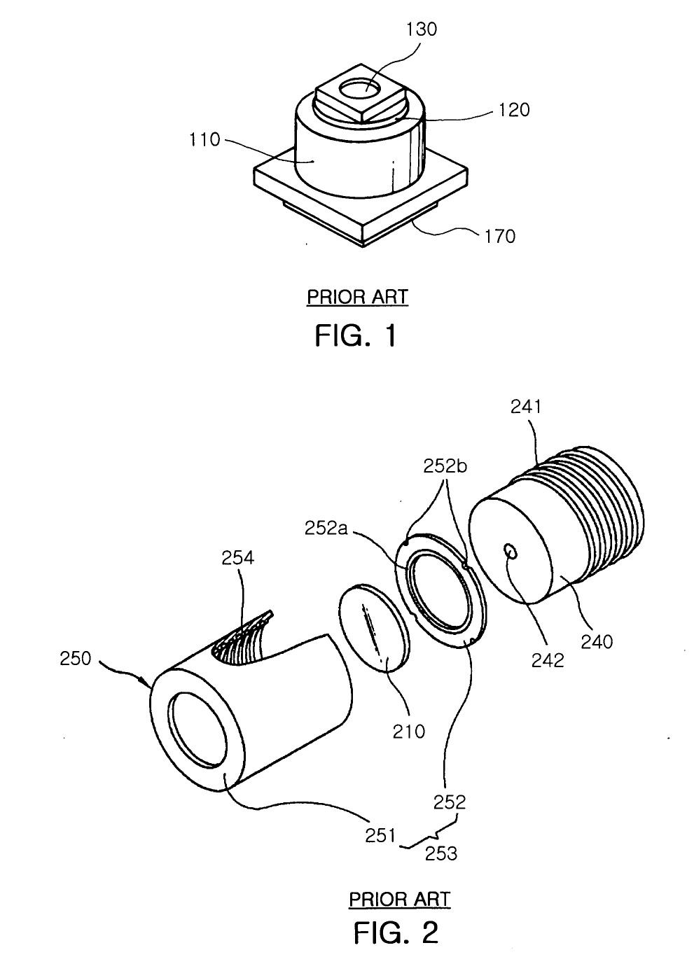

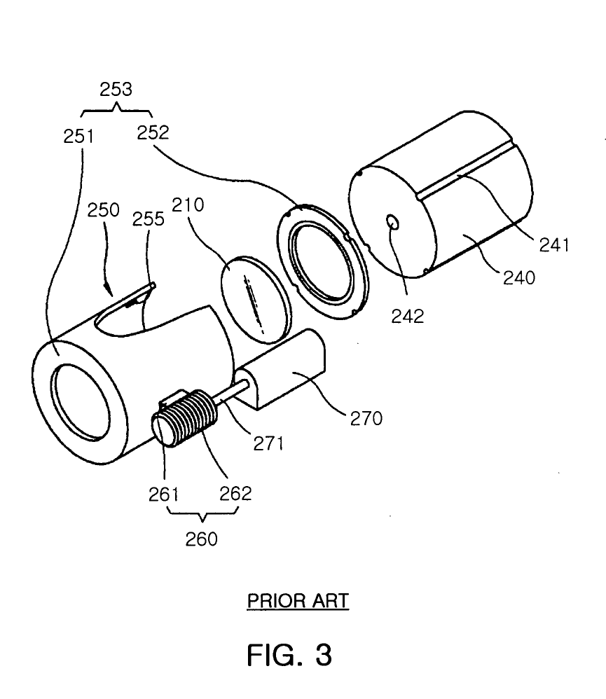

### DESCRIPTION OF THE PREFERRED EMBODIMENTS

Embodiments of the present invention will be described in detail with reference to the accompanying drawings.

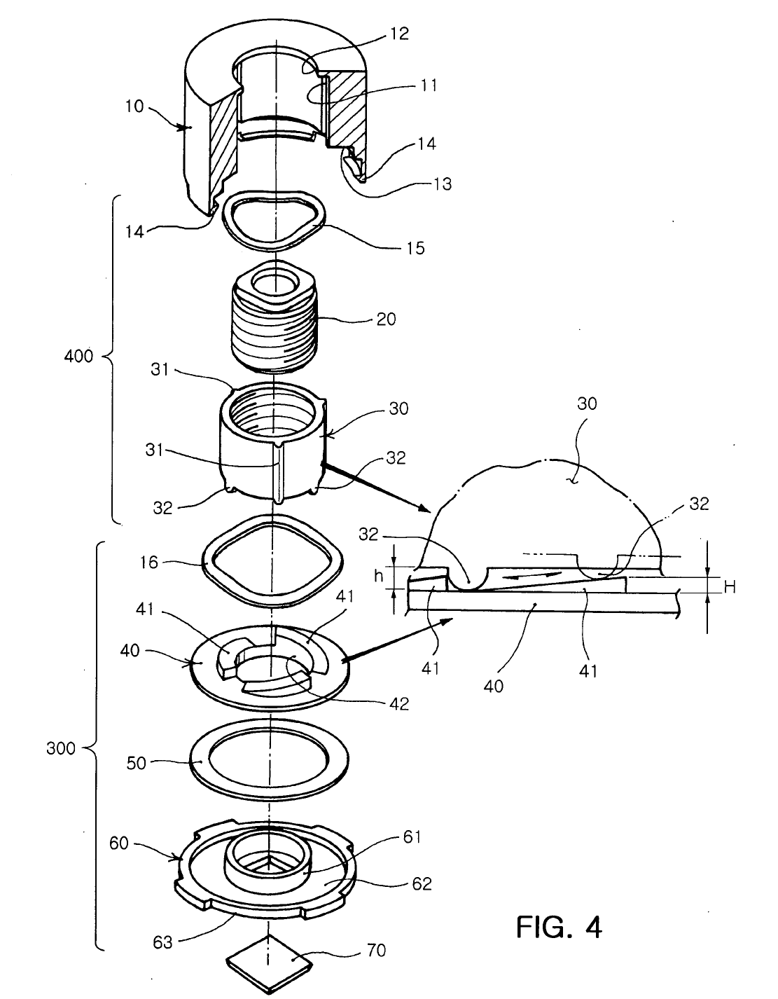

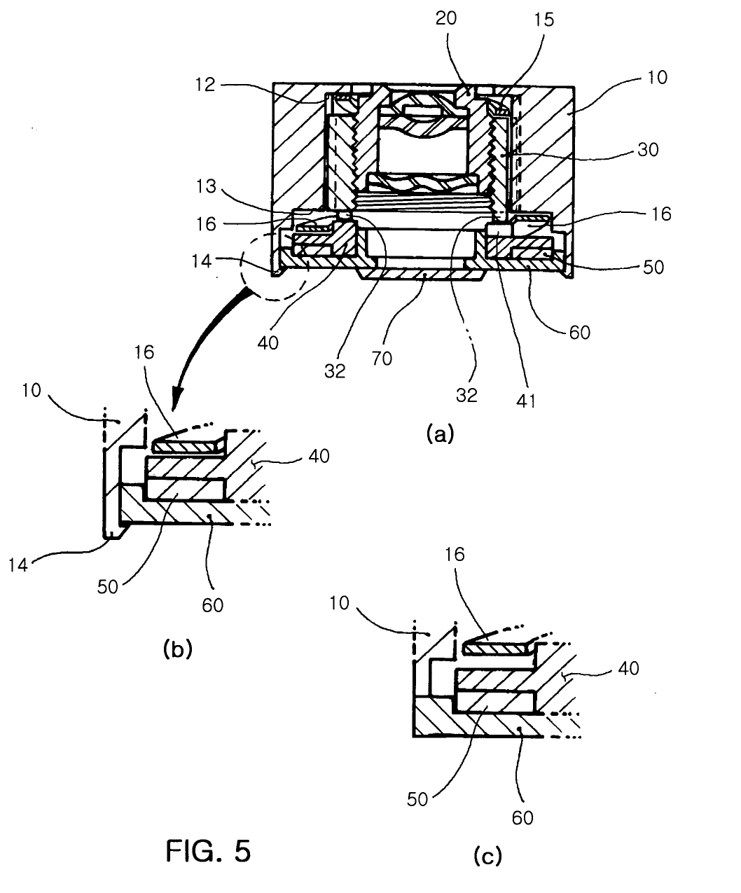

FIG. 4 is a perspective view illustrating an essential component of a lens-positioning device according to the present invention, and FIGS. 5a to 5c are cross-sectional views illustrating the central portion of the lens-positioning device of the present invention.

Referring to FIG. 4, a lens-positioning device of a camera module according to the present invention comprises an actuating part 300, a positioning part 400, and a housing 10, which receives the actuating part 300 and the positioning part 400.

The actuating part 300 includes a ring-shaped piezoelectric actuator 50, which generates a mechanical actuating force in response to a voltage applied to the piezoelectric actuator 50, and a rotating plate 40 positioned on an upper surface of the piezoelectric actuator 50 to be rotated around an optical axis of at least one lens in response to the actuating force generated by the piezoelectric actuator 50.

Here, the lens is fixed into the barrel holder 30, as described hereinafter.

Preferably, the rotating plate 40 has one or more slant cams 41 protruded from an upper surface thereof and gradually increasing in height.

Preferably, the actuating part 300 further comprises a bottom plate 60 provided with an image sensor 70. The bottom plate 60 has a mounting groove depressed on an upper surface of the bottom plate 60 to mount the piezoelectric actuator 50 thereon.

The piezoelectric actuator 50 acts to transmit an actuating force to the rotating plate 40 and rotate the rotating plate 40, and has a ring shape to allow light to pass through the lens and reach the image sensor 70.

In view of allowing clockwise and counter-clockwise rotations, easy miniaturization, and a long life span, the piezoelectric actuator 50 may be a traveling wave actuating-type piezoelectric actuator rather than a standing wave actuating-type. The piezoelectric actuator 50 may have a displacement of several hundred nanometers to several dozen micrometers, and an actuating frequency of several kHz or more.

Meanwhile, the positioning part 400 is provided with a hollow barrel holder 30, which contacts an upper surface of the rotating plate 40 and has the lens fixed into the barrel holder 30. Upon rotation of the rotating plate 30, the positioning part 400 is linearly moved in the direction of the optical axis of the lens by virtue of contact between a lower surface of the barrel holder 30 and the upper surface of the rotating plate 30.

Preferably, the barrel holder 30 has one or more cam followers 32 protruded from the lower surface of the barrel holder 30 corresponding to the slant cams 41 to contact the slant cams 41 of the rotating plate 40. The positioning part 400 may be moved by virtue of the contact between the slant cams 41 and the cam followers 32 upon the rotation of the rotating plate 40.

Furthermore, the barrel holder 30 preferably has a lens barrel 20 fixed thereto, and the lens barrel 20 has at least one lens therein.

Here, when a plurality of lenses are used, the lenses are assembled to the lens barrel 20 such that the optical axes of the lenses are identical to each other, and the lens barrel 20 is formed with threads around an outer peripheral surface thereof to match with threads around an inner peripheral surface of the barrel holder 30.

Furthermore, the lens barrel 20 is assembled to the inner peripheral surface of the barrel holder 30, and fixed thereto by means of an epoxy member after compensating an initial position.

Meanwhile, the housing 10 has a hollow shape, and receives the actuating part 300 and the positioning part 400 therein. The housing 10 is formed with a guide means to guide the positioning part 400 to be linearly moved in the direction of the optical axis of the lens.

Embodiments of the present invention will now be described in detail as follows.

Referring to FIG. 4, the slant cams 41 of the rotating plate 40 are protruded from the upper surface of the rotating plate 40, and spaced a uniform distance at each predetermined angle in a circumferential direction around the optical axis of the lens. The cam followers 32 of the barrel holder 30 are protruded from the lower surface of the barrel holder 30 to correspond to the slant cams 41, respectively.

Preferably, the slant cams 41 are formed every 120° in the circumferential direction around the optical axis of the lens on the upper surface of the rotating plate 40 for a stable three-point support, and the cam followers corresponding to the slant cams 41 are also protruded from the lower surface of the barrel holder 30 every 120°.

More preferably, as shown in an enlarged part of FIG. 4, in order to prevent interference between the lower surface of the barrel holder 30 and the slant cams 41, each of the slant cams 41 has a maximum length H lower than that of the cam followers 32.

Furthermore, each of the cam followers 32 preferably has a semi-spherical shape to allow the cam follower 32 to have a point contact with a slant surface of the slant cam 41. Nevertheless, each of the cam followers 32 may have an arc-shaped cross-section to allow the cam follower 32 to have a line contact with the slant surface of the slant cam 41.

As shown in the enlarged part of FIG. 4, each of the cam followers 32 contact the end of adjoining slant cam at a position having a height of zero, and thus, the contact between the cam followers and the upper surface of the rotating plate, where the slant cams are not provided, is restricted. Thus, the cam followers 32 contact the slant cams 41 only along the slant surface of the slant cams 41.

That is, in the case where the lens barrel 20 is moved upward, the cam followers 32 are moved from the position having the height of zero of the slant cams 41 to a position having a height of H of the slant cams 41 along the slant surface of the slant cams 41. One of the cam followers 32 indicated by a double dotted line of FIG. 4 contacts the slant surface of the slant cam 41.

Meanwhile, in order to realize effective positioning of the lens, the barrel holder 30 and the lens barrel 20 fixed thereto are preferably moved in the direction of the optical axis of the lens in proportion to a rotational angle of the rotating plate 40, and a moving distance of the barrel holder 30 is lower than the maximum height H of the slant cams.

That is, the slant cams 41 are shaped to provide a contact height between the cam followers 32 and the slant cams 41 linearly increasing or decreasing according to the rotational angle of the rotating plate. As a result, with the slant cams 41 having such a shape, the rotational angle of the rotating plate 40 required for positioning the lens can be linearly determined.

Meanwhile, the lens, used for a camera module of miniaturized optical devices, such as camera phones, digital cameras, and the like, has a small size. Accordingly, if such a lens is rotationally moved instead of being linearly moved, the optical axis between the image sensor 70 and the lens can be varied due to aberration of the lens and incompatibility between a rotational axis and the optical axis of the lens, thereby impeding the high resolution.

In order to solve such a problem, the lens is preferably moved in the direction of the optical axis.

In order to realize a linear movement of the lens in the direction of the optical axis, the barrel holder 30 has one or more slide portions 31 protruded on the outer peripheral surface thereof, and the housing 10 has one or more guide portions 11 depressed on an inner peripheral surface of the housing corresponding to the slide portions 31 to receive and allow the slide portions 31 to slide therein. The slide portions 31 and the guide portions 11 are preferably formed parallel to the optical axis of the lens.

On the contrary, the housing 10 may have one or more slide portions 11 protruded from an inner peripheral surface thereof, and the barrel holder 30 may have one or more guide portions 31 depressed on an outer peripheral surface of the barrel holder 30.

Furthermore, if the contact positions between the cam followers 32 and the slant surface of the slant cams 41 are changed to an inner or outer side of the slant surface, it is difficult to ensure the positioning of the lens in proportion to the rotational angle of the rotating plate 40. Accordingly, in order to ensure accurate positioning of the lens, the cam followers 32 protruded from the lower surface of the barrel holder 30 preferably contact the slant cams 41 while maintaining a predetermined radius around the optical axis, and for this purpose, it is necessary to maintain the predetermined radius such that the rotational axis of the rotating plate 40 is identical to the optical axis of the lens.

Preferably, the bottom plate 60 has a cylinder-shaped hollow rotation guide 61 protruded from the upper surface thereof and having the optical axis of the lens as the central axis. The rotation guide 61 may be inserted into an inner peripheral surface 42 of the rotating plate 41 penetrating through the center of the rotating plate 41 to restrict movement in a radial direction of the rotating plate 41 upon the rotation of the rotating plate 41.

Meanwhile, the housing 10 is closed, at a lower portion, by the bottom plate 60, which is fixed to the lower portion of the housing 10 to restrict relative rotation between the housing and the bottom plate. Thus, the housing 10 is not affected by the actuation of the piezoelectric actuator 50.

Preferably, the housing 10 has a plurality of toothed upper engagement jaws 14 on the lower end of the outer peripheral surface thereof, and the bottom plate 60 has lower engagement jaws 63 corresponding to the upper engagement jaws 14 to engage with the upper engagement jaws 14. Engagement between the upper engagement jaws 14 and the lower engagement jaws 63 allows the bottom plate 60 to be fixed to the housing 10.

More preferably, as shown in FIG. 5b, each of the upper engagement jaws 14 comprises a protrusion extending to the center of the housing 10, and allowing the engagement between the upper engagement jaws 14 and the lower engagement jaws 63 to be maintained.

At this time, the bottom plate 60 is assembled to the housing 10 from the lower portion of the housing 10 to an upper portion of the housing. When assembled, the protrusions of the upper engagement jaws 14 are widened outwardly, and engaged with the lower engagement jaws 63. Then, the protrusions of the upper engagement jaws 14 can support the bottom plate 60 by virtue of elasticity of the protrusions.

That is, the engagement between a depressed portion of the outer peripheral surface of the bottom plate 60 and a prominent portion of the lower end of the outer peripheral surface of the housing 10 provides a cross-section as shown in FIG. 5b, and the engagement between a protruded portion of the outer peripheral surface of the bottom plate 60 and a depressed portion of the lower end of the outer peripheral surface of the housing provides a cross-section as shown in FIG. 5c.

Without additional processes, such as welding, screw fastening, and the like, the housing 10 and the bottom plate 60 may be fixed to each other by means of the upper engagement jaws 14 and the lower engagement jaws 63 having such a construction, thereby providing an effect of improved assembly.

Meanwhile, as shown in FIGS. 4 and 5, the positioning part 400 further comprises a first elastic member 15 to elastically compress the slant cams 41 and the cam followers 32 so that they contact each other. The first elastic member 15 is preferably a ring-shaped preloaded wave spring in order to supply a predetermined elastic force on an overall slant surface and to provide convenience of assembly.

In order to elastically compress the slant cams 41 and the cam followers 32, and to be compressed when the barrel holder 30 is moved in the opposite direction of the image sensor 70, thereby providing a moving space, the first elastic member 15 is preferably located between an upper step 12 formed around an inner surface of the housing 10 and the upper surface of the barrel holder 30, as shown in FIG. 5a.

The actuating part 300 further comprises a second elastic member 16 to compress the upper surface of the piezoelectric actuator 50 and the lower surface of the rotating plate 40 with a preloaded elastic force. The second elastic member 16 is preferably a ring-shaped preloaded wave spring in order to supply a predetermined elastic force to the overall slant surface and to provide convenience of assembly.

As shown in FIG. 5a, the second elastic member 16 is preferably located between the upper surface of the rotating plate 40 and a middle step 13 formed around the inner surface of the housing 10, compressing the upper surface of the piezoelectric actuator 50 and the lower surface of the rotating plate 40.

Meanwhile, the lens-positioning device of the camera module of the invention may further comprise a controller, not shown, to control actuation of the piezoelectric actuator 50 in response to a signal from a sensor, which detects the distance from the camera module to an object, or in response to a user's instruction in order to perform the automatic focusing. The lens-positioning device may further comprise an additional group of lenses comprising one or more lenses to conduct the optical zoom or close-up function.

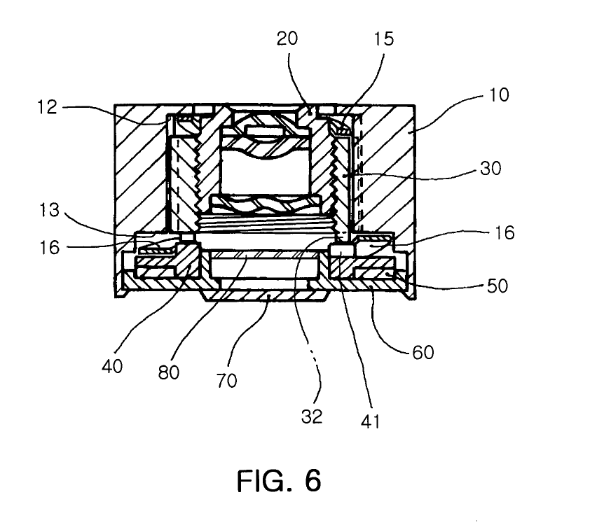

FIG. 6 is a cross-sectional view illustrating the central portion of a lens-positioning device according to another embodiment of the present invention, which comprises an additional group of lenses 80.

As shown in FIG. 6, the lens-positioning device of the camera module according to the present invention may further comprise the additional group of lenses 80 comprising one or more lenses to conduct the optical zoom or close-up function. In this case, the optical zoom or close-up function can be performed by virtue of cooperation of the lens in the lens barrel 20, which can be moved linearly on the optical axis, and the lenses of the additional group of lenses 80.

At this time, the additional group of lenses 80 may be provided to the lens-positioning device such that they can also be moved by the structure for positioning the lens of the lens barrel 20, or provided thereto at a fixed position of the lens-positioning device against the image sensor 70.

In the case where the additional group of lenses 80 is provided to the lens-positioning device such that they can be moved, the lens-positioning device may have a structure to allow the additional group of lenses 80 to be subordinately moved depending on a moving distance of the lens barrel 20 or may further comprise an additional actuating part 300 and positioning part 400 for allowing the additional group of lenses 80 to be moved independent of the movement of the lens barrel 20.

In the case where the additional group of lenses 80 is provided to the lens-positioning device at the fixed position thereof against the image sensor 70, the additional group of lenses 80 may be fixed to the rotation guide 61 penetrating through the center of the bottom plate 60. Alternatively, the additional group of lenses 80 may be disposed at a location above the housing 10, if a predetermined distance can be maintained between the location and the image sensor 70.

At this time, characteristics of the lens in the lens barrel 20 and of the lenses of the additional group of lenses 80 may be appropriately selected according to a mounting location, and to whether the lenses are moved or not.

The optical axis of the group of lenses 80 must be fixed to be identical to that of the lens in the barrel holder 30 and in the lens barrel 20 fixed to the barrel holder 30.

Preferably, the lens-positioning device of the camera module may further comprise a controller, not shown, to control the actuation of the piezoelectric actuator 50 thereby moving the barrel holder 30 and the lens holder 20 fixed to the barrel holder 30 after receiving an instruction to perform the close-up, zoom-in or zoom-out function from the user.

Operation of one embodiment according to the present invention with the construction as described above will now be described with reference to FIGS. 4 and 5.

First, a voltage is applied to the piezoelectric actuator 50. At this time, the piezoelectric actuator 50 may be actuated in response to a signal from the controller, not shown, to control actuation of the piezoelectric actuator 50 in response to the sensor to detect the distance of an object from a camera module or by means of indication of a user.

When an actuating signal is applied to the piezoelectric actuator 50, the piezoelectric actuator 50 generates a mechanical actuating force by virtue of a traveling wave (sine wave), and the rotating plate 40 is rotated by virtue of the actuating force from the piezoelectric actuator 50. At this time, the second elastic member 16 may be additionally provided to the lens-positioning device in order to maintain a contact force between the piezoelectric actuator 50 and the rotating plate 40.

Rotation of the rotating plate 40 causes the slant cams 41 to rotate, thereby increasing the contact height between the slant cams 41 and the cam followers 32 at the lower surface of the barrel holder 30.

At this time, the cam followers 32 contacting the slant cams 41 are pushed in the opposite direction of the image sensor 70, and the slide portions 31 protruded on the outer peripheral surface of the barrel holder 30 in the direction of the optical axis are guided along the guide portions 11 depressed on the inner peripheral surface of the housing 10 in the direction of the optical axis, so that the barrel holder 30 and the lens barrel 20 fixed to the barrel holder 30 are moved in the direction of the optical axis opposite to the image sensor 70. Here, the first elastic member 15 may also be provided to the lens-positioning device in order to maintain the contact force between the slant cams 41 and the cam followers 32.

Meanwhile, if voltage is no longer applied to the piezoelectric actuator 50, the piezoelectric actuator 50 stops actuating, and positioning of the lens is stopped.

Alternatively, when the lens-positioning location determined by the sensor detecting the distance between the camera module and the object is arrived or when the user indicates to stop actuating, the controller applies an actuation stop signal to the piezoelectric actuator 50, thereby stopping the positioning of the lens.

On the contrary, in the case where the lenses are moved towards the image sensor 70, the lens-positioning device is operated by the same principle as described above.

Generally, since the traveling wave actuating-type piezoelectric actuator 50 has a displacement of several hundred nanometers to several dozen micrometers, and an actuating frequency of several kHz or more, it is possible to perform a minute displacement adjustment. Accordingly, the traveling wave actuation-type piezoelectric actuator 50 can realize the accurate positioning of the lens, thereby providing high resolution and high sharpness images, and can be miniaturized to allow itself to be applied to the camera module of a miniaturized optical device.

Meanwhile, the optical zoom function or the close-up function can be also performed by the operation as described above.

In this case, it is only necessary to enlarge the moving distance of the lens in order to perform the optical zoom function of a high magnification. This can be accomplished by increasing the height of the slant cams 41 by the moving distance of the lens required for performing the optical zoom function, and by establishing the piezoelectric actuator 50 to have a larger displacement and/or a higher actuating frequency in order to perform a rapid positioning operation.

As apparent from the above description, according to the present invention, the lens is positioned by way of converting a rotational positioning of the lens caused by actuation of the piezoelectric actuator to a linear positioning of the lens, thereby realizing a miniaturized and accurate lens-positioning device with a simple construction.

Furthermore, according to the present invention, a minute focusing can be realized by means of the piezoelectric actuator, thereby allowing high resolution and high sharpness images.

Furthermore, according to the present invention, the miniaturized lens-positioning device can be utilized for the focusing, the optical zooming, close-up and the like of the camera module, which is used for camera phones, digital cameras, and the like.

It should be understood that the embodiments and the accompanying drawings as described above have been described for illustrative purposes and the present invention is limited only by the following claims. Further, those skilled in the art will appreciate that various modifications, additions and substitutions are allowed without departing from the scope and spirit of the invention as set forth in the accompanying claims.

What is claimed is:

1. A lens-positioning device of a camera module, comprising:
an actuating part including a ring-shaped piezoelectric actuator to generate a mechanical actuating force by virtue of a voltage applied to the actuator and a rotating plate positioned on an upper surface of the piezoelectric actuator to be rotated around an optical axis of a lens in response to the actuating force generated by the piezoelectric actuator;
a positioning part provided with a hollow barrel holder and linearly moved in a direction of the optical axis of the lens upon rotation of the rotating plate, the hollow barrel holder contacting an upper surface of the rotating plate and having at least one lens fixed to an inner portion of the barrel holder; and
a hollow housing receiving the actuating part and the positioning part, and having a guide means to guide the positioning part to be linearly moved in the direction of the optical axis of the lens,
wherein, when the rotating plate is rotated in response to the actuating force generated by the piezoelectric actuator, the positioning part is guided along the guide means of the housing through contact between a lower portion of the barrel holder and the upper surface of the rotating plate, and is then moved in the direction of the optical axis of the lens.

2. The lens-positioning device as set forth in claim 1, wherein the rotating plate has one or more slant cams protruded from the upper surface thereof and gradually increasing in height, and the barrel holder has one or more cam followers corresponding to the slant cams and protruded from the lower surface of the barrel holder to contact the slant cams, the positioning part being moved by virtue of contact between the slant cams and the cam followers upon the rotation of the rotating plate around the optical axis of the lens.

3. The lens-positioning device as set forth in claim 1, wherein the actuating part further comprises a bottom plate provided with an image sensor, and having a mounting groove depressed on an upper surface of the bottom plate to mount the piezoelectric actuator thereon.

4. The lens-positioning device as set forth in claim 1, wherein the piezoelectric actuator is a traveling wave-actuating type piezoelectric actuator.

5. The lens-positioning device as set forth in claim 2, wherein the slant cams are protruded from the upper surface of the rotating plate, and spaced a uniform distance at each predetermined angle in a circumferential direction around the optical axis of the lens, and the cam followers are protruded from the lower surface of the barrel holder to correspond to the slant cams.

6. The lens-positioning device as set forth in claim 5, wherein each of the slant cams has a maximum length H lower than a maximum height h of each of the cam followers so that a lower surface of the barrel holder does not interfere with the slant cam.

7. The lens-positioning device as set forth in claim 6, wherein the positioning part is moved in the direction of the optical axis of the lens in proportion to a rotational angle of the rotating plate, and has a moving distance lower than the maximum height H of the slant cams.

8. The lens-positioning device as set forth in claim 2, wherein the barrel holder has a lens barrel fixed to the inner portion of the barrel holder, the lens barrel having at least one lens therein.

9. The lens-positioning device as set forth in claim 1, wherein the barrel holder has one or more slide portions protruded on an outer peripheral surface thereof, and the housing has guide portions depressed on an inner peripheral surface of the housing corresponding to the slide portions to receive the slide portions while allowing the slide portions to slide therein, the slide portions and the guiding portionp being formed parallel to the optical axis of the lens.

10. The lens-positioning device as set forth in claim 1, wherein the housing has one or more slide portions protruded from an inner peripheral surface thereof, and the barrel holder has guide portions depressed on an outer peripheral surface of the barrel holder corresponding to the slide portions to receive the slide portions while allowing the slide portions to slide therein, the slide portions and the guiding portion being formed parallel to the optical axis of the lens.

11. The lens-positioning device as set forth in claim 3, wherein the bottom plate has a cylinder-shaped hollow rotation guide protruded from an upper surface thereof and having the optical axis of the lens as a central axis, the rotation guide being inserted into an inner peripheral surface of the rotating plate penetrating through the center of the rotating plate to restrict movement in a radial direction of the rotating plate upon the rotation of the rotating plate.

12. The lens-positioning device as set forth in claim 3, wherein the housing has a plurality of toothed upper engagement jaws on the lower end of an outer peripheral surface of the housing, and the bottom plate has lower engagement jaws formed on an outer peripheral surface of the bottom plate corresponding to the upper engagement jaws to engage with the upper engagement jaws, the upper engagement jaws and the lower engagement jaws being engaged together, allowing the bottom plate to be fixed to the housing.

13. The lens-positioning device as set forth in claim 12, wherein each of the upper engagement jaws comprise a protrusion extending to the center of the housing and allowing engagement between the upper engagement jaws and the lower engagement jaws to be maintained.

14. The lens-positioning device as set forth in claim 1, wherein the positioning part further comprises a first elastic member to elastically compress the slant cams and the cam followers so that they contact each other.

15. The lens-positioning device as set forth in claim 14, wherein the first elastic member is a ring-shaped preloaded wave spring.

16. The lens-positioning device as set forth in claim 15, wherein the first elastic member is located between an upper step formed around an inner surface of the housing and an upper surface of the barrel holder.

17. The lens-positioning device as set forth in claim 1, wherein the actuating part further comprises a second elastic member to compress the upper surface of the piezoelectric actuator and a lower surface of the rotating plate with a preloaded elastic force.

18. The lens-positioning device as set forth in claim 17, wherein the second elastic member is a ring-shaped preloaded wave spring.

19. The lens-positioning device as set forth in claim 18, wherein the second elastic member is located between the upper surface of the rotating plate and a middle step formed around an inner surface of the housing.

20. The lens-positioning device as set forth in claim 1, further comprising a controller to control actuation of the piezoelectric actuator in response to a signal from a sensor to detect a distance from the camera module to an object or by indication of a user.

21. The lens-positioning device as set forth in claim 1, further comprising an additional group of lenses comprising one or more lenses to conduct an optical zoom or close-up function.

22. The lens-positioning device as set forth in claim 21, wherein the additional group of lenses has an optical axis identical to that of the lens fixed into the barrel holder.

23. The lens-positioning device as set forth in claim 22, further comprising a controller to control actuation of the piezoelectric actuator in response to actuation instructions including a close-up, zoom-in and zoom-out function from a user.
